(19) United States
(12) Patent Application Publication
(10) Pub. No.: US 2023/0163554 A1
(43) Pub. Date: May 25, 2023

(54) OPTICAL FIBER AMPLIFIER AND RARE EARTH DOPED OPTICAL FIBER

(71) Applicant: NIPPON TELEGRAPH AND TELEPHONE CORPORATION, Tokyo (JP)

(72) Inventors: Shinichi AOZASA, Musashino-shi, Tokyo (JP); Yoko YAMASHITA, Musashino-shi, Tokyo (JP); Takashi MATSUI, Musashino-shi, Tokyo (JP); Kazuhide NAKAJIMA, Musashino-shi, Tokyo (JP); Taiji SAKAMOTO, Musashino-shi, Tokyo (JP); Nobutomo HANZAWA, Musashino-shi, Tokyo (JP); Noriyuki ARAKI, Musashino-shi, Tokyo (JP); Ryota IMADA, Musashino-shi, Tokyo (JP); Yuto SAGAE, Musashino-shi, Tokyo (JP)

(73) Assignee: NIPPON TELEGRAPH AND TELEPHONE CORPORATION, Tokyo (JP)

(21) Appl. No.: 17/913,097

(22) PCT Filed: Mar. 30, 2020
(86) PCT No.: PCT/JP2020/014645

§ 371 Date: Sep. 20, 2022

(51) Int. Cl. H01S 3/067; G02B 6/32; G02B 3/08

(52) U.S. Cl. CPC H01S 3/06754; G02B 3/08; G02B 6/32; H01S 3/1608

(57) ABSTRACT

An object of the present disclosure is to implement a clad-excitation rare-earth-added optical fiber amplifier with a high light-to-light conversion efficiency. The present disclosure is an optical fiber amplifier having, in a longitudinal direction of a rare-earth-added optical fiber, a light collection structure that collets an excitation light, which propagates through a clad portion, into a core portion.

### TECHNICAL FIELD

The present disclosure relates to a rare-earth-added optical fiber and an optical fiber amplifier including the same.

### BACKGROUND ART

For an optical fiber amplifier including a rare-earth-added optical fiber, a core excitation method and a method using clad excitation have been proposed (for example, see Non-Patent Literature 1).

### CITATION LIST

### Non-Patent Literature

Non-Patent Literature 1: Kazi S. Abedin, “Cladding-Pumped Multicore Fiber Amplifier for Space Division Multiplexing”, Handbook of Optical Fibers, Springer Nature Singapore Pte Ltd. 2018.

### SUMMARY OF THE INVENTION

### Technical Problem

A clad excitation method achieves a high efficiency in light-to-current conversion in an excitation light source as compared with a core excitation method. However, a light-to-light conversion efficiency (an efficiency of conversion from an excitation light to a signal light) would be insufficient due to a decrease in excitation light power density in a rare-earth-added optical fiber. It should be noted that a light-to-light conversion efficiency usually tends to monotonically increase with respect to an increase in excitation light power density.

An object of the present disclosure is to implement a clad-excitation rare-earth-added optical fiber amplifier with a high light-to-light conversion efficiency.

### Means for Solving the Problem

Specifically, an optical fiber and an optical fiber amplifier according to the present disclosure each have a refractive index distribution structure provided at least at a part of a rare-earth-added optical fiber in a longitudinal direction and configured to collect an excitation light, which propagates through a clad portion, into a core portion.

### Effects of the Invention

According to the present disclosure, it is possible to implement a clad-excitation rare-earth-added optical fiber amplifier with a high light-to-light conversion efficiency.

### BRIEF DESCRIPTION OF DRAWINGS

FIG. 1 illustrates a configuration example of an optical fiber amplifier according to Exemplary Embodiment 1.

FIG. 2 illustrates a configuration example of an optical fiber amplifier according to Exemplary Embodiment 2.

FIG. 3 illustrates a configuration example of an optical fiber amplifier according to Exemplary Embodiment 3.

FIG. 4 illustrates a configuration example of an optical fiber amplifier according to Exemplary Embodiment 4.

### DESCRIPTION OF EMBODIMENTS

Embodiments of the present disclosure will be described below in detail with reference to the drawings. It should be noted that the present disclosure is not limited to the embodiments described below. These examples of implementation are merely by way of example and the present disclosure can be implemented in embodiments provided with a variety of modifications and improvements on the basis of knowledge of those skilled in the art. It should be noted that components reference signs of which are the same herein and in the drawings are identical to each other.

### Summary of the Present Disclosure

According to the present disclosure, a structure that generates a light collection effect is given to a rare-earth-added optical fiber, in which excitation light power density decreases, thereby enhancing the excitation light power density in the rare-earth-added optical fiber to improve a light-to-light conversion efficiency. In particular, the present disclosure is characterized by enabling a desired structure to be formed later using a laser or the like after a rare-earth-added optical fiber is manufactured.

### Exemplary Embodiment 1

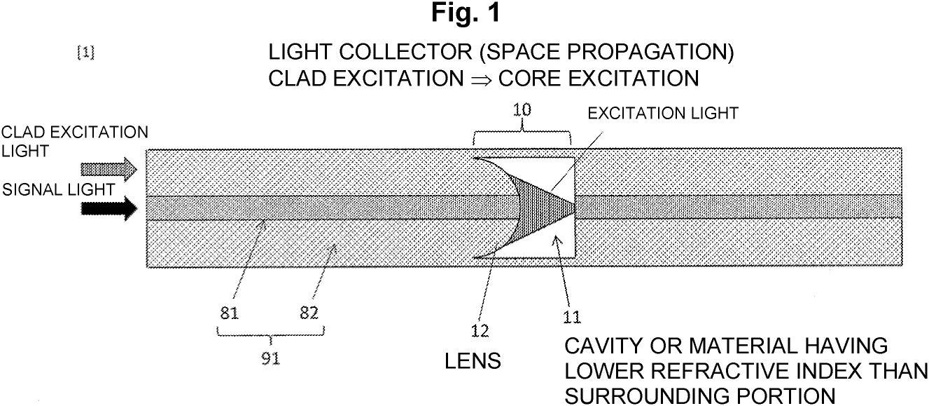

FIG. 1 illustrates an example of an optical fiber amplifier according to this exemplary embodiment. The optical fiber amplifier according to this exemplary embodiment is a clad-excitation optical fiber amplifier that uses an excitation light, which propagates through a clad portion 82, to amplify a signal light, which propagates through a core portion 81. Erbium is added, as a rare-earth ion to add, to the core portion 81.

In this exemplary embodiment, as illustrated in FIG. 1, a light collector 10 that enables collecting light in a fiber longitudinal direction is provided in a rare-earth-added optical fiber 91 with the core portion 81 coated with the clad portion 82. In the light collector 10, light collected by a semispherical lens 12 propagates through the space instead of propagating through a waveguide. A region 11 for the space propagation is a cavity or is formed of a material having a lower refractive index than glass in a portion around the region 11.

In the region 11 for the space propagation, a cavity can be formed using a femtosecond laser or a refractive index can be lowered by virtue of stress relaxation resulting from glass remelting. The lens 12 can be formed by changing refractive indexes of the core portion 81 and the clad portion 82 during the formation of the cavity portion or the low refractive index portion.

The core portions 81 are opposed to each other at the region 11 for the space propagation. The lens 12 is formed at one of the core portions 81 opposed to each other. The lens 12 is formed by changing the refractive indexes of the core portion 81 and the clad portion 82. A focal length of the lens 12 is set at the other of the core portions 81 opposed to each other. This causes the excitation light and the signal light outputted from the lens 12 to be coupled to the other of the core portions 81 after propagating through the region 11.

A simulation for a light-to-light conversion efficiency was performed, where in an erbium-added optical fiber amplifier (EDFA) added with erbium ions as rare-earth ions, a signal light was caused to enter the core portion 81 and an excitation light was caused to enter the clad portion 82. As a result of forming the region 11 and the lens 12 by cavity machining, the excitation light power density became 2.1 times higher and the light-to-light conversion efficiency became 1.8 times higher than those before the formation of a lens structure. In a case of the region 11 and the lens 12 being formed by changing the refractive indexes, the excitation light power density became 1.3 times higher and the light-to-light conversion efficiency became 1.2 times higher.

It should be noted that specifications of the optical fiber amplifier that was used were an Er addition concentration: 1000 ppm, a fiber length of the rare-earth-added optical fiber 91: 10 m, a diameter of the core portion 81: 4 µm, a relative refractive index difference: 2%, a wavelength of the excitation light: 980 nm, an excitation light power: 3 W, an input signal light power: -10 dBm, and a wavelength of the signal light: 1550 nm. Further, the light collector 10 was provided every 1 mm in a longitudinal direction over an entire fiber length. Regarding a size of the light collector 10, the lens 12 was 80 µm in outer diameter and 100 µm in focal length.

A shape of the lens 12 is not limited to a semispherical shape and any shape enabling an excitation light to be coupled to the other of the core portions 81 can be employed.

Further, the rare-earth ion to add is not limited to erbium and praseodymium, ytterbium, thulium, neodymium, etc. are usable to achieve a comparable effect.

### Exemplary Embodiment 2

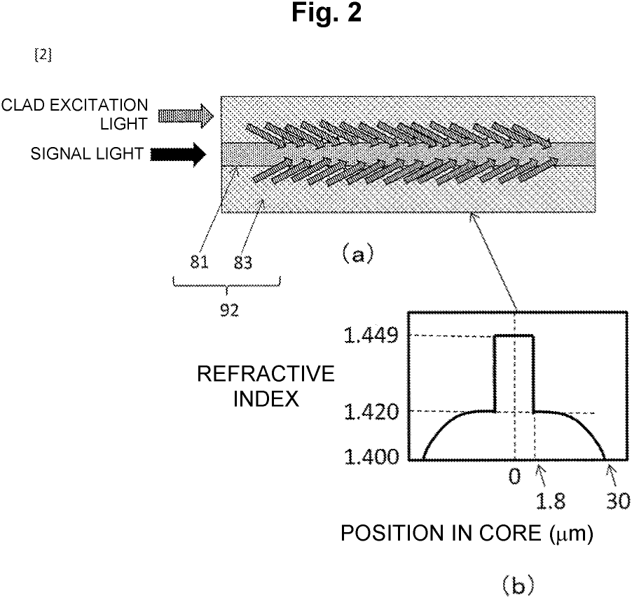

In this exemplary embodiment, as illustrated in FIG. 2(a), a graded index (GI) clad portion 83 that enables collecting light in a fiber longitudinal direction is provided in a rare-earth-added optical fiber 92. FIG. 2(b) illustrates a refractive index distribution profile. As propagating in the fiber longitudinal direction, the excitation light excited by the clad portion 83 is collected toward the core portion 81, being brought into a state close to substantial core excitation. Further, a GI structure, which is usually given by adjusting distribution of added ions during manufacturing of a fiber preform, can also be formed by inducing a change in refractive index using a femtosecond laser or the like.

A simulation for a light-to-light conversion efficiency was performed, where in an erbium-added optical fiber amplifier (EDFA) added with erbium ions as rare-earth ions, a signal light was caused to enter the core portion 81 and an excitation light was caused to enter the clad portion 82. As a result, the excitation light power density became 3.2 times higher and the light-to-light conversion efficiency became 2.1 time higher than those in a case where a clad portion had no GI structure and was constant in refractive index.

It should be noted that specifications of the optical fiber amplifier that was used were an Er addition concentration: 500 ppm, a fiber length of the rare-earth-added optical fiber 92: 15 m, a diameter of the core portion 81: 4 µm, a relative refractive index difference: 2.1%, a wavelength of the excitation light: 980 nm, an excitation light power: 4W, an input signal light power: -8 dBm, and a wavelength of the signal light: 1540 nm.

The clad portion 83 with the GI structure may be provided across the rare-earth-added optical fiber or may be provided at a part of the rare-earth-added optical fiber. With the clad portion 83 with the GI structure being provided at least at a part of the rare-earth-added optical fiber in the longitudinal direction, a comparable effect is achievable.

Further, the rare-earth ion to add is not limited to erbium and praseodymium, ytterbium, thulium, neodymium, etc. are usable to achieve a comparable effect.

### Exemplary Embodiment 3

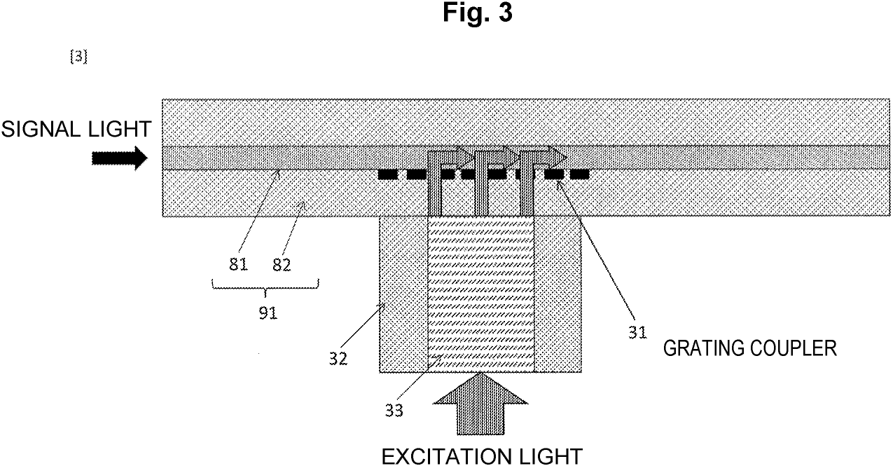

In this exemplary embodiment, as illustrated in FIG. 3, in the rare-earth-added optical fiber 91, a grating coupler 31 is provided that couples an excitation light caused to enter through a side surface of the rare-earth-added optical fiber 91 by using an excitation light introducer 32, to the core portion 81 while collecting it thereinto. Further, a grating structure can be formed by inducing a change in refractive index using a femtosecond laser or the like.

A simulation for a light-to-light conversion efficiency was performed, where in an erbium-added optical fiber amplifier (EDFA) added with erbium ions as rare-earth ions, a signal light was caused to enter the core portion 81 and an excitation light was caused to enter through the excitation light introducer 32. As a result, the excitation light power density became 1.8 times higher and the light-to-light conversion efficiency became 1.5 times higher than those in a typical clad-excitation EDFA.

Further, specifications of the optical fiber amplifier that was used were an Er addition concentration: 500 ppm, a fiber length of the rare-earth-added optical fiber 91: 10 m, a diameter of the core portion 81: 6 µm, a relative refractive index difference: 0.8%, a wavelength of the excitation light: 980 nm, an excitation light power: 6W, an input signal light power: -8 dBm, a wavelength of the signal light: 1550 nm, and a grating pitch: 1.3 µm.

Further, the rare-earth ion to add is not limited to erbium and praseodymium, ytterbium, thulium, neodymium, etc. are usable to achieve a comparable effect.

### Exemplary Embodiment 4

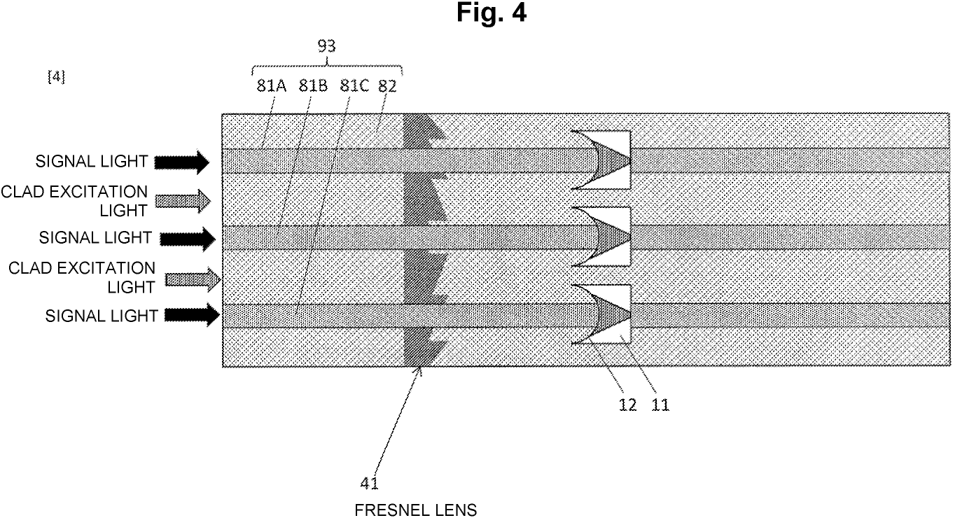

In this exemplary embodiment, as illustrated in FIG. 4, a Fresnel lens 41 that uniformizes the power density of the excitation light in the clad portion 82 and the semispherical lens 12 that can collect light in the fiber longitudinal direction are provided in a rare-earth-added multicore optical fiber 93 including a plurality of core portions 81A, 81B, and 81C. A region 11 for the space propagation is a cavity or is formed of a material having a lower refractive index than glass in a portion around the region 11 as in Exemplary Embodiment 1.

The excitation light in the clad portion 82 is trapped in the clad portion 82 by virtue of total reflection on an outer interface of the core portion 82, so that an intensity of the excitation light near a fiber periphery tends to be lower than an intensity of the excitation light near a fiber center. Accordingly, it is of concern that in the multicore optical fiber 93 for amplification, the intensity of the excitation light in the core portions 81A and 81C located outside relative to the central core portion 81B decreases with a gain lowered.

The Fresnel lens 41, which converts the excitation light at an outer side in the clad portion 82 to a parallel light, has a function to reduce an influence of the total reflection on the outer interface of the clad portion 82 to keep the intensity of the excitation light high at the outer side in the clad portion 82. As a result, in this embodiment, localization of the excitation light in the clad portion 82 can be eliminated with a difference in gain between the cores improved. Further, the Fresnel lens 41 can be formed by inducing a change in refractive index using a femtosecond laser or the like.

A simulation for a light-to-light conversion efficiency was performed, where in an erbium-added six-core optical fiber amplifier (EDFA) added with erbium ions as rare-earth ions, a signal light was caused to enter each of the core portions 81 and an excitation light was caused to enter the clad portion 82. As a result, the average excitation light power density of the plurality of core portions 81 became 1.5 times higher and the light-to-light conversion efficiency became 1.3 times higher than those in a typical clad-excitation six-core EDFA. Further, the maximum gain deviation between the cores was improved from 2 dB to 0.5 dB.

Further, specifications of the optical fiber amplifier that was used were an Er addition concentration: 500 ppm, a fiber length of the rare-earth-added optical fiber 91: 10 m, a diameter of the core portion 81: 5 µm, a relative refractive index difference: 1.2%, a wavelength of the excitation light: 980 nm, an excitation light power: 8W, an input signal light power: -8 dBm, and a wavelength of the signal light: 1550 nm. Further, the Fresnel lens 41 and the lens 12 are each provided every 2 mm in the longitudinal direction over a fiber entire length.

The Fresnel lens 41 may be formed across a cross section of the clad portion 82 of the multicore optical fiber 93 as illustrated in FIG. 4 or may be formed only in the clad portion 82 near an outer periphery of the multicore optical fiber 93. For example, the Fresnel lens 41 may be formed only at outer peripheral sides relative to the core portions 81A and 81C located at the outer side in the multicore optical fiber 93.

Further, the rare-earth ion to add is not limited to erbium and praseodymium, ytterbium, thulium, neodymium, etc. are usable to achieve a comparable effect.

### Effect of the Present Disclosure

According to the present disclosure, a clad-excitation rare-earth-added optical fiber amplifier is also allowed to achieve a light-to-light conversion efficiency comparable to that of a core-excitation one. Further, a multicore optical fiber amplifier has an effect to reduce a difference in gain between cores.

### Point of the Present Disclosure

A structure that collects a clad excitation light in a longitudinal direction of a rare-earth-added optical fiber is provided and, consequently, a light-to-light conversion efficiency can be improved.

### INDUSTRIAL APPLICABILITY

The present disclosure is applicable to information communication industries.

Reference Signs List

| | |
|---|---|
| 10 | Light collector |
| 11 | Region |
| 12 | Lens |
| 31 | Grating coupler |
| 32 | Excitation light introducer |
| 41 | Fresnel lens |
| 81, 81A, 81B, 81C Core portion | |
| 82, 83 Clad portion | |
| 91, 92 Rare-earth-added optical fiber | |
| 93 | Multicore optical fiber |

1. An optical fiber amplifier comprising
a refractive index distribution structure provided at least at a part of a rare-earth-added optical fiber in a longitudinal direction and configured to collect an excitation light, which propagates through a clad portion, into a core portion.

2. The optical fiber amplifier according to claim 1, comprising:
a cavity portion or a low refractive index portion formed in the rare-earth-added optical fiber; and
a lens formed from one core portion of core portions that are in contact with the cavity portion or the low refractive index portion and the clad portion around the core portion, wherein
the excitation light outputted from the clad portion included in the lens is coupled to an other one of the core portions that are in contact with the cavity portion or the low refractive index portion after propagating through the cavity portion or the low refractive index portion.

3. The optical fiber amplifier according to claim 1, wherein the clad portion of the rare-earth-added optical fiber has a graded index refractive index profile.

4. The optical fiber amplifier according to claim 1 comprising
a grating formed on a surface of or in a vicinity of the core portion of the rare-earth-added optical fiber by a change in a refractive index of the clad portion of the rare-earth-added optical fiber, wherein
an excitation light introducer configured to input the excitation light toward the grating is provided on a side surface of the rare-earth-added optical fiber.

5. The optical fiber amplifier according to claim 1, wherein
the rare-earth-added optical fiber is a multicore optical fiber comprising a plurality of the core portions, and
a Fresnel lens formed by a change in a refractive index of the clad portion is provided in the clad portion of the multicore optical fiber.

6. The rare-earth-added optical fiber usable in the optical fiber amplifier according to claim 1.
